(19) United States
(12) Patent Application Publication
(10) Pub. No.: US 2009/0254885 A1
(43) Pub. Date: Oct. 8, 2009

(54) SYSTEM AND A METHOD FOR MANAGING CONFIGURATIONS OF AUTOMATIC TESTS

(76) Inventors: Guy Arieli, Even Yehuda (IL); Yoram Shamir, Kiriat Ono (IL); Golan Derazon, Ramat Hasharon (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/062,553

(22) Filed: Apr. 4, 2008

(51) Int. Cl. G06F 11/36

(52) U.S. Cl. 717/125; 717/124

(57) ABSTRACT

The present invention is a new and innovative system and method for managing and organizing the set of configurations of tests independently of the definition and execution of scenario suit of the tests. The proposed system and method enable managing the setups and teardown configurations for any type of test of any type of tested item. Additionally, embodiments of the proposed configuration management system and method may include recovery protocol for defining the needed configurations when tests fail. According to embodiments of the present invention the setup and teardown configurations are organized in a tree hierarchy, each branch of the hierarchic configuration tree is designated for a group of tests. The system further verifies that the different configurations do not contradict each other

### FIELD OF INVENTION

The present invention relates to the field of automatic tests and more particularly it relates to systems and methods for managing the configurations in automatic tests.

### BACKGROUND OF THE PRIOR ART

Frequently changing demands and pressure to achieve results in short periods of time inhibit the automation of Quality Assurance (QA) procedures. Although many tests share full or partial configurations with other tests, most often the configurations of these tests are written and executed specifically for each test. This leads to massive redundant code writing, increasing difficulties in the managing configuration codes and waste of execution time.

Prior art discloses several systems and methods for automating testing procedures. Sivakumar et al., “Computer software testing management”, U.S. Pat. No. 6,219,829 which is incorporated herein as if fully set forth herein, discloses a test management system which makes use of concepts such as encapsulation and inheritance in order to provide test structuring and test execution capabilities. The test management system allows the defining of- and the reuse of rules specified at different levels in the test structure.

Sivakumar et al., “Apparatus and system for testing of software”, U.S. Pat. No. 2,006,143,533 which is incorporated herein as if fully set forth herein, discloses a system and apparatus for testing software products. The apparatus includes a manager that receives a request to run a test of a software product, and communicates with a resource to load the software product into the resource, and to automatically configure the software product for the test. Also included is a system including the manager and a test automator. The test automator receives the request to run the test from the manager, and runs the test on the software.

However, none of the patents and patent applications provide a full-scale modular solution for automating the configurations of tests independently of the execution of the tests themselves. Moreover, such a solution should minimize code redundancy and maximized test configuration execution efficiency.

### SUMMARY OF INVENTION

Disclosed is a system for managing the execution of set of configurations for tests, wherein the tests are run on a tested item in accordance with a test scenario. The system comprises an interface for defining set of configurations for corresponding tests and a runtime module for executing the configurations of the tests in accordance with the execution of the scenario suite. The management of the configurations is performed independently of the scenario suite. The system may further include a second module for preventing contradictory configurations for the same test. The configurations may be organized in a hierarchic tree.

Each configuration may include at least one of the following: setup configuration, teardown configuration; failed protocol and teardown configuration. The setup configuration may be executed before the test is run. The teardown configuration may be executed after the test is run and is terminated normally. The failed teardown configuration may be executed after the test is run and is terminated with an error status. The system may also include a recovery protocol whereas the recovery protocol defines which configurations are executed after the test is run and is terminated with an error status.

The system may further include a management tool. The management tool may include an interface for defining the configurations for the tests and a runtime module for executing the configurations of the tests before and after the tests are run. The system may further include parameters for the configurations, wherein the same configurations may be executed using different parameters.

Also disclosed is a method for managing the execution of configurations for tests, wherein the tests are run on a tested item in accordance with a test scenario suite. The method comprises the steps of defining at least one configuration for at least one test and executing the configurations of the tests in accordance with the execution of the scenario suite.

The method may further include the step of ensuring that different configurations for the same test do not include contradictions. The execution may be performed in accordance with user defined criteria. The configurations may be organized in a hierarchic tree.

Each configuration may include at least one of the following: setup configuration, teardown configuration, failed teardown configuration and protocol. The setup configuration may be executed before the test is run. The teardown configuration may be executed after the test is run and is terminated normally. The failed teardown configuration may be executed after the test may be run and is terminated with an error status.

The method may further include the step of defining a recovery protocol whereas the recovery protocol defines which failed teardown configurations are executed after the test is run and is terminated with an error status. The method may further include the step of defining parameters for the configurations, wherein the same configurations are executed using different parameters.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a schematic diagram illustrating a hierarchic tree of test configurations in accordance with embodiments of the present invention.

The drawings together with the description make apparent to those skilled in the art how the invention may be embodied in practice.

No attempt is made to show structural details of the invention in more detail than is necessary for a fundamental understanding of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF SOME EMBODIMENTS OF THE INVENTION

The present invention is a new and innovative system and method for managing and organizing set of configurations of tests independently of the execution of the tests themselves. The proposed system and method enable managing the setups and teardown configurations for any type of test of any type of tested item. Additionally, embodiments of the proposed configuration management system and method may include recovery protocol for defining the needed configurations when tests fail. According to embodiments of the present invention the setup and teardown configurations are organized in a tree hierarchy, each branch of the hierarchic configuration tree is designated for a group of tests.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

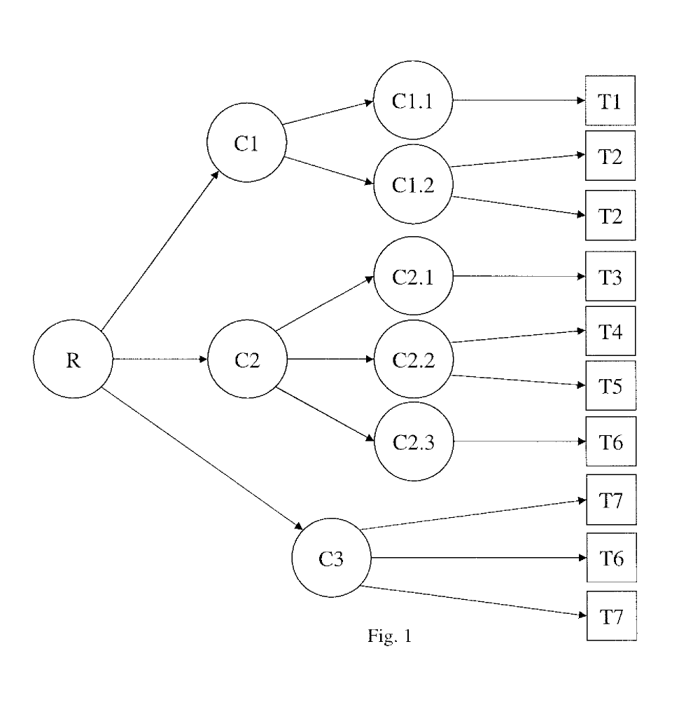

FIG. 1 is a schematic diagram illustrating a hierarchic tree test configuration in accordance with embodiments of the present invention. The illustrated example includes a three tier tree; however, embodiments of the present invention may include any number of tiers according to the specification of the given tests. In order to run any of the tests (T1 to T7) the system executes all of the configurations on the configuration tree leading to the particular test. Each of the configurations includes a definition for the setup and the teardown of the tests. For instance, in order to run test T1 the system executes the setup configuration C1 and setup configuration C1.1. Optionally, after test T1 is executed the system may execute teardown configuration C1.1 and teardown configuration C1. Similarly, in order to run only test T2 the system executes the setup configuration C1 and setup configuration C1.2. Optionally, after test T1 is executed the system may execute teardown configuration C1.2 and teardown configuration C1, and so on.

The tree hierarchy enables executing partial setup and teardown configurations when running more than one test sequentially. For instance, if the test scenario suite demands running tests T4, T5 and T6 in succession, the system executes setup configuration C2 and setup configuration C2.2 in order to run test T4. After test T4 is completed, the system can simply run test T5, since it shares the same configuration route as test T4. After test T5 is completed, the system executes teardown configuration C2.2 and setup configuration C2.3 in order to execute test T6, since tests T5 and T6 share the same configuration of C2. Thus, the configuration tree defines which setup and teardown configurations need to be executed when running a sequence of tests in the tests scenario suite.

According to embodiments of the present invention all configurations on the hierarchic configuration tree may include parameters. In such cases, for different test protocols the same configurations are executed before the test is run, but with different parameters. Thus, the tests are still defined in the same position in the hierarchic configuration tree even if their configurations should be executed with different parameters.

According to embodiments of the present invention several configuration trees may be defined for each of the tests. Each of the configuration trees may relate to a different aspect or aspects for each of the tested items. The system verifies that the different configurations do not contradict each other. Whenever contradictions are found the system notifies the user about the contradictions and suggest ways to bypass it.

In order to manage the configuration trees the proposed system and method also includes a configuration management tool. The configuration management tool enables users to define the configuration trees and parameters and to associate each test to the proper set of configurations for each tested item. Additionally, according to some embodiments, the configuration management tool ensures that no configuration incompatibilities are defined for each of the tests in the different configuration trees. Using the configuration management tool the configuration trees are defined independently of the definitions of any test scenario suite. The management configuration tools enable defining which configurations should be executed before each test is run no matter which test scenario suite is executed. Thus, the proposed system and method enable management of test configurations independently of test scenario suites. The configuration management tool includes an interface through which users can define the configuration trees and a runtime module for executing the setup and teardown configurations before running each test. Using the management tool users of the system may define the order according to which the different configuration trees should run.

According to some embodiments of the present invention, users can also define recovery protocols of setup and teardown configurations for failed tests in addition to defining the setup and teardown configurations for the normal operation. The recovery protocols may be defined for each of the tests, failed teardown configurations may be defined for each of the configurations on the configuration tree. The recovery protocols define which failed teardown configurations should be executed whenever a test ends with an error status, is aborted or terminates in any abnormal mode for any reason. In addition to the configuration steps which should be executed on the tested item the recovery protocol may include instructions for executing configurations before the next test is run. For instance, in the above example test T5 is run after test T4. If test T4 terminates with an error message, recovery protocol of test T4 is executed. Recovery protocol of test T4 may, for example, include instructions to run failed teardown configuration C2 and to return to root configuration R before running the next test. Thus, after test T4 terminates and failed teardown configuration C2.2 is executed, the system executes teardown configuration C2, setup configuration C2 and setup configuration C2.2 before running test T5.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A system for managing and organizing the execution of configurations for tests, wherein said tests are run on a tested item in accordance with a test scenario suite, said system comprising:
an interface for defining set of configurations for corresponding tests;
a runtime module for executing said configurations of said tests in accordance with the execution of said test scenario suite;
wherein said management and organization of said configurations is determined independently of the definition and execution of said test scenario suite.

2. The system of claim 1 further including a second module for preventing contradictory configurations for the same test.

3. The system of claim 1 wherein said configurations are organized in a hierarchic tree.

4. The system of claim 1 wherein each configuration includes at least one of the following: setup configuration, teardown configuration; failed protocol and teardown configuration.

5. The system of claim 4 wherein said setup configuration is executed before said test is run.

6. The system of claim 4 wherein said teardown configuration is executed after said test is run and is terminated normally.

7. The system of claim 4 wherein said failed teardown configuration is executed after said test is run and is terminated with an error status.

8. The system of claim 7 further including a recovery protocol whereas said recovery protocol defines which configurations are executed after said test is run and is terminated with an error status.

9. The system of claim 1 further including a management tool wherein said management tool includes:
an interface for defining said configurations for said tests;
a runtime module for executing said configurations of said tests before the tests are run.

10. The system of claim 1 further including parameters for said configurations, wherein the same said configurations are executed using different parameters.

11. A method for managing the execution of configurations for tests, wherein said tests are run on a tested item in accordance with a test scenario suite, said method comprises the steps of:
defining set of configurations for corresponding tests;
executing said configurations of said tests in accordance with the execution of said scenario suite;
wherein said management and organization of said configurations is determined independently of the definition and execution of said test scenario suite.

12. The method of claim 11 further including the step of ensuring that different configurations for the same test do not include contradictions.

13. The method of claim 11 wherein said execution is performed in accordance with user defined criteria.

14. The method of claim 11 wherein said configurations are organized in a hierarchic tree.

15. The method of claim 11 wherein each configuration includes at least one of the following: setup configuration, teardown configuration; failed teardown configuration and protocol.

16. The method of claim 15 wherein said setup configuration is executed before said test is run.

17. The method of claim 15 wherein said teardown configuration is executed after said test is run and is terminated normally.

18. The method of claim 15 wherein said failed teardown configuration is executed after said test is run and is terminated with an error status.

19. The method of claim 18 further including the step of defining a recovery protocol whereas said recovery protocol defines which failed teardown configurations are executed after said test is run and is terminated with an error status.

20. The method of claim 11 further including the step of defining parameters for said configurations, wherein the same said configurations are executed using different parameters.
